(19) United States
(12) Patent Application Publication
(10) Pub. No.: US 2006/0199601 A1
(43) Pub. Date: Sep. 7, 2006

(54) Method of transforming message and mobile station using the same

(75) Inventor: Yoon Ho Cho, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/367,984

(22) Filed: Mar. 3, 2006

(30) Foreign Application Priority Data
Mar. 3, 2005 (KR) 10-2005-0017775

(51) Int. Cl. H04Q 7/20

(52) U.S. Cl. 455/466

(57) ABSTRACT

A method for transforming and presenting a message and a mobile station using the transformed message is provided. By transforming a received message, such as a voice or character message, into tactilely sensed symbols, the contents of the message can be recognized via touch or sight by a user having a visual and/or auditory disability.

### CROSS-REFERENCE TO RELATED APPLICATIONS

This application claims the benefit of the Korean Patent Application No. 10-2005-0017775, filed on Mar. 3, 2005, which is hereby incorporated by reference as if fully set forth herein.

### BACKGROUND OF THE INVENTION

1. Field of the Invention

The present invention relates to a communication service and method of supporting the same, and more particularly, to a method for transforming and presenting a message and a mobile station using the transformed message. Although the present invention is suitable for a wide scope of applications, it is particularly suitable for transforming an output format of a received message.

2. Description of the Related Art

Generally, mobile communication services include a voice communication service and a data transfer service. The mobile communication services further include such a character transfer service such as a short message service (hereinafter abbreviated SMS).

A mobile communication terminal (i.e., mobile station) supporting the character transfer service receives a prescribed message according to the corresponding service and then outputs a character sequence corresponding to the received message on a display device (e.g., liquid crystal display (LCD)).

A service that displays a character sequence and outputs artificial sounds corresponding to the character sequence has been recently developed. Such a service is referred to as a TTS (text to speech) service.

FIG. 1 is a diagram of a protocol stack structure for a general SMS. As illustrated in FIG. 1, a message center (MC) is a bearer service end point and a base station (BS) is a bearer service relay point.

The message center (MC) sends an SMS message to the base station (BS). The base station (BS) then transmits the received SMS message to an identified mobile station (MS).

The SMS message received by the mobile station (MS) is delivered to an SMS teleservice layer, an uppermost protocol layer, via a physical layer, a link layer, an SMS relay layer and an SMS transport layer in order. The SMS teleservice layer delivers the received SMS message to an upper application. The mobile station (MS) is provided with the application to display the received message on a liquid crystal display.

In this way, the SMS message delivered to the application is finally displayed as text on the liquid crystal display according to a user's selection option. As illustrated, the text includes numbers, characters and symbols and the SMS message is transformed into voice by a TTS function within the mobile station (MS).

Interfaces between tasks for performing the TTS function within the mobile station (MS) are explained with reference to FIG. 2. FIG. 2 illustrates a block diagram of interfaces between tasks for performing a TTS function according to the related art.

As illustrated in FIG. 2, an SMS task 10 is a task corresponding to an application among SMS protocol processing steps. The SMS task 10 represents an SMS message received by a mobile station (MS) as text, such as numbers, characters and symbols, based on the protocol stack structure shown in FIG. 1 and then displays the text to a user.

In order to perform a TTS (text to speech) function, the SMS task 10 provides text corresponding to an SMS message to a TTS task 30. The TTS task 30 detects voice data corresponding to the provided task with reference to a TTS database 20 provided within the mobile station (MS). As illustrated, the detected voice data is a digitalized voice and the TTS database 20 is a memory storing digital voice data corresponding to text, such as numbers, characters and symbols.

Subsequently, the TTS task 30 provides the detected voice data to a sound task 40. The sound task 40 provides the voice data to a speaker driver 50, which outputs the voice data as an analog signal via a speaker 60.

According to the related art, the received character information is output as visual information displayed on a screen or as auditory information via speaker. For example, a mobile station (MS) represents a received SMS message as text, such as numbers, characters and symbols, or converts the numbers and characters of the text to voice for output via a speaker 60.

However, the related art visual or auditory output system cannot deliver the received character information to a user who has a visual and/or auditory disability. In particular, the related art SMS cannot service a user incapable of hearing and vision. Furthermore, in a mobile station (MS) that supports a related art TTS function, there is no way to provide the received character information to a user with such disabilities.

Therefore, there is a need for an SMS that can service a user incapable of hearing and vision and a mobile station (MS) that supports that can provide the received character information to a user with such disabilities.

### SUMMARY OF THE INVENTION

The present invention is a method for transforming and presenting a message and a mobile station using the transformed message such that contents of a received message can be recognized via touch or sight by a user having a visual and/or auditory disability by transforming the received message, such as a voice or character message, into tactilely sensed symbols. Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In one aspect of the present invention, a method of presenting a message in a mobile communications terminal is provided. The method includes transforming a received message into a digital signal and presenting the content of the received message to a user via vibration and/or light.

It is contemplated that the received message is a character message including text configured with characters, numbers and/or symbols. It is further contemplated that the received message is a voice message. It is further contemplated that the received message is a video message including images and the method further includes extracting text from the video message and transforming the extracted text into a digital signal.

It is contemplated that transforming the received message includes utilizing digital codes representing a Morse code dot and a Morse code dash. It is further contemplated that presenting the content of the received message includes generating a first signal and a second signal for controlling a drive current and/or a drive voltage, the first signal corresponding to the Morse code dot and the second signal corresponding to the Morse code dash.

It is contemplated that transforming the received message further includes utilizing digital codes that cause the drive current and/or drive voltage to be applied for a shorter time for the Morse code dot than for the Morse code dash. It is further contemplated that presenting the content of the received message includes controlling a luminescent lamp using the digital signal as a control signal.

It is contemplated that transforming the received message includes utilizing digital codes representing a Morse code dot and a Morse code dash in order to generate signals for controlling a drive current and/or a drive voltage of the luminescent lamp such the drive current and/or drive voltage of the luminescent lamp is applied for a shorter time for the Morse code dot than for the Morse code dash. It is further contemplated that presenting the content of the received message includes controlling a vibration device using the digital signal as a control signal.

It is contemplated that transforming the received message includes utilizing digital codes representing a Morse code dot and a Morse code dash in order to generate signals for controlling a drive current and/or a drive voltage of the vibration device such that the drive current and/or drive voltage of the vibration device is applied for a shorter time for the Morse code dot than for the Morse code dash. It is further contemplated that the method includes presenting the content of the received message to a user textually and/or audibly.

In another aspect of the present invention, a method of transforming a message in a mobile communications terminal is provided. The method includes presenting the content of a received message to a user via a visual display and/or a speaker, transforming the received message into a digital signal and presenting the content of the received message to a user via a vibration device and/or an illuminating device.

It is contemplated that the received message is either a character message or a voice message, the character message including text configured with characters, numbers and/or symbols. It is further contemplated that transforming the received message includes utilizing digital codes representing a Morse code dot and a Morse code dash and presenting the content of the received message includes generating a first signal and a second signal for controlling a drive current and/or a drive voltage of the vibration device and/or illuminating device, the first signal corresponding to the Morse code dot and the second signal corresponding to the Morse code dash such that the drive current and/or drive voltage is applied for a shorter time for the Morse code dot than for the Morse code dash.

In another aspect of the present invention, a mobile communication terminal is provided. The mobile communication terminal includes a transforming unit adapted to transform a received message into a digital signal, a presenting unit adapted to represent the content of the received message to a user, the unit including a vibration device and/or a luminescent lamp and a control unit adapted to control the presenting unit using the digital signal as a control signal.

It is contemplated that the transforming unit is further adapted to transform a received character message including text configured with characters, numbers and/or symbols. It is further contemplated that the transforming unit is adapted to transform a received voice message.

It is contemplated that the transforming unit is further adapted to utilize digital codes representing a Morse code dot and a Morse code dash. It is further contemplated that the mobile communication terminal includes a memory unit adapted to store the digital codes and the transforming unit is further adapted to transform the received message into the digital signal with reference to the memory.

It is further contemplated that the control unit is further adapted to generate a first signal and a second signal for controlling a drive current and/or a drive voltage of the presenting unit, the first signal corresponding to the Morse code dot and the second signal corresponding to the Morse code dash. It is further contemplated that the control unit is adapted to cause the drive current and/or drive voltage to be applied for a shorter time for the Morse code dot than for the Morse code dash. Preferably, the mobile communication terminal further includes a visual display unit and/or a sound display unit and the control unit is further adapted to control the presenting unit and the visual display unit and/or sound display unit such that the content of the received message is represented to a user in a plurality of formats.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed. These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a diagram of a protocol stack structure for a general SMS.

FIG. 2 is a block diagram of interfaces between tasks for performing a conventional TTS function.

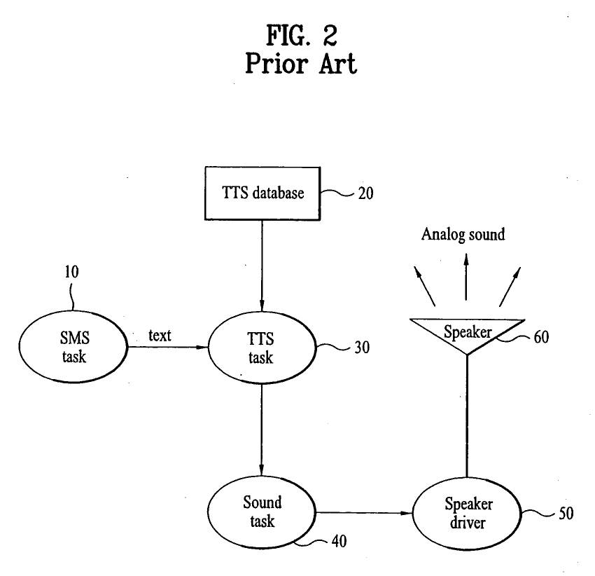

FIG. 3 is a block diagram of interfaces between tasks for a message transformation according to the present invention.

FIG. 4 is a flowchart of a process for transforming a character message according to the present invention.

### DETAILED DESCRIPTION OF THE PREFERRED EMBODIMENTS

The present invention relates to a method for transforming and presenting a message and a mobile station using the transformed message such that contents of a received message can be recognized via touch or sight by a user having a visual and/or auditory disability by transforming the received message, such as a voice or character message, into tactilely sensed symbols. Although the present invention is illustrated with respect to a mobile communication device, it is contemplated that the present invention may be utilized anytime it is desired to present information in a received message to a user having a visual and/or auditory disability.

Reference will now be made in detail to the preferred embodiments of the present invention, examples of which are illustrated in the accompanying drawings. Wherever possible, the same reference numbers have been used throughout the drawings to refer to the same or like parts.

In the present invention, after a message has been received, the received message is transformed into a format of a corresponding mode according to an operational mode. The operating mode may be a normal mode, a TTS mode, a vibration mode or a luminescent mode.

According to a normal mode, the received message is output as text that was represented when a calling user created the message. According to a TTS mode, the received message is transformed into voice and output as both voice and text. According to a vibration mode, the received message is transformed into a digital signal and on/off states of a vibration motor are controlled according to the digital signal such that the received message is presented as vibration. According to a luminescent mode, the received message is transformed into a digital signal and on/off states of a light-emitting lamp are controlled according to the digital signal such that the received message is as light.

In transforming the received message into a digital signal in the vibration or luminescent mode, a previously prepared code system is used. Therefore, the transformed digital signal mentioned in the present invention is a type of code sequence.

The above-identified operation modes can be overlapped with each other. For example, the modes are not independent and at least two of the modes may be simultaneously available. Specifically, a mobile station may simultaneously operate in both vibration and luminescent modes to output a received message using both vibration and light.

It is preferable that a received message is a character message created with text including characters, numbers and/or symbols, a voice message created with the voice of a calling user or a video message created with combined text and image. For example, an SMS message corresponds to a character message.

In the following description, Morse code is used as a code system for transforming a message. Morse code is a code that represents English alphabets, Korean consonants and vowels, numbers and special symbols as combinations of short outgoing current (dot) and relatively long outgoing current (dash) as illustrated in Table 1 and Table 2.

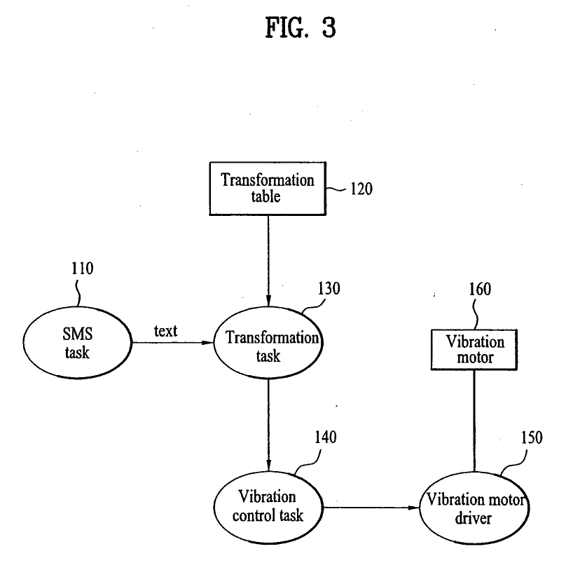

Interfaces between tasks for performing a message transforming function according to the present invention are explained with reference to FIG. 3. FIG. 3 is a block diagram of interfaces between tasks for a message transformation according to one embodiment of the present invention, in which an SMS message is received in a vibration mode.

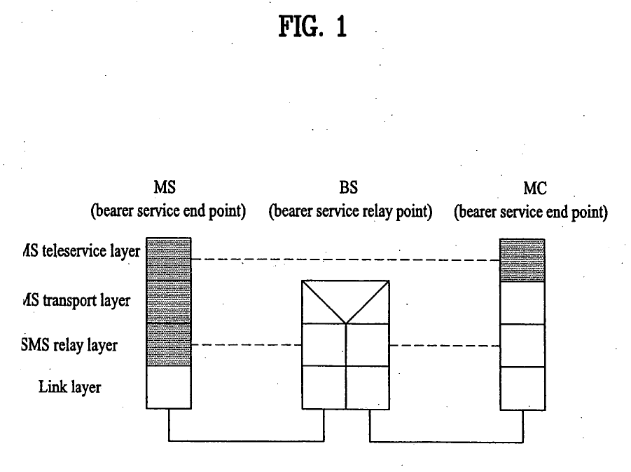

As illustrated FIG. 3, an SMS task 110 is a task corresponding to an application in SMS protocol processing steps. The SMS task 110 is a task that presents an SMS message received by a mobile station (MS) as text, such as numbers, characters and symbols, to a user according to the protocol stack structure illustrated in FIG. 1.

In the vibration mode the present invention, the SMS task 110 provides text corresponding to the received SMS message to a transformer task 130. The transformer task 130 detects Morse codes corresponding to input text with reference to a transformation table 120 provided within the mobile station (MS). As illustrated, the detected Morse codes are digitalized codes and the transformation table 120 is stored in a memory that includes digital codes corresponding to the Morse codes illustrated in Table 1 and Table 2, the Morse codes having been digitized in advance.

TABLE 1

| letters | Morse Code | letters | Morse Code |
|---|---|---|---|
| ┐ | . - . . | A | . - |
| └ | . . - . | B | - . . . |
| ⊂ | - . . . | C | - . - . |
| [symbol] | . . . - | D | - . . |
| [symbol] | - - | E | . |
| [symbol] | . - - | F | . . - . |
| [symbol] | - - . | G | - - . |
| [symbol] | - . - | H | . . . . |
| [symbol] | . - - . | I | . . |
| [symbol] | - . - . | J | . - - - |
| [symbol] | - . . - | K | - . - |
| Ε | - - . . | L | . - . . |
| [symbol] | - - - | M | - - |
| [symbol] | . - - - | N | - . |
| [symbol] | . | O | - - - |
| [symbol] | . . | P | . - - . |
| [symbol] | - | Q | - - . - |
| [symbol] | . . . | R | . - . |
| [symbol] | . - | S | . . . |
| [symbol] | - . | T | - |
| [symbol] | . . . . | U | . . - |
| π | . - . | V | . . . - |
| — | - . . | W | . - - |
| \| | . - . | X | - . . - |
| [symbol] | - - . - | Y | - . - - |
| [symbol] | - . - - | Z | - - . . |

The transformer task 130 transforms the input text into digital codes with reference to the transformation table 120. As illustrated, the transformed digital codes are recognizable by a vibration control task 140 and represent dots and dashes according to the Morse codes.

TABLE 1
▪ numbers

| | regular | abbreviated |
|---|---|---|
| 1 | · - - - - | · - |
| 2 | · · - - - | · · - |
| 3 | · · · - - | · · · - |
| 4 | · · · · - | · · · · - |
| 5 | · · · · · | · · · · · |
| 6 | - · · · · | - · · · · |
| 7 | - - · · · | - · · · |
| 8 | - - - · · | - · · |
| 9 | - - - - · | - · |
| 0 | - - - - - | - |

▪various symbols

| | | |
|---|---|---|
| period | · | · - · - · - |
| comma | , | - - · · - - |
| question mark | ? | · · - - · · |
| colon | : | - - - · · · |
| dash | - | - · · · · - |
| oblique line | / | - · · - · |
| left parenthesis | ( | - · - - · |
| right parenthesis | ) | - · - - · - |
| quotation mark | “ | · - · · - · |
| double dash | = | - · · · - |
| correction mark | korean | · · · - · |
| correction mark | english | · · · · · · · · |
| cross | + | · - · - · |

The digital code corresponding to a dot of the Morse code is a control signal that controls a drive current or drive voltage supplied to a vibration motor 160 for a short time. The digital code corresponding to a dash of the Morse code is a control signal that controls a drive current or drive voltage supplied to drive the vibration motor 160 for a longer time.

The transformer task 130 provides the transformed digital code to the vibration control task 140. Specifically, the vibration control task 140 provides the input digital code as a control signal that controls an on/off state of the vibration motor 160 provided within the mobile station (MS).

In this way, the vibration motor driver 150 switches the current supplied to drive the vibration motor 160 according to the input control signal, which is a type of control code. Therefore, the vibration motor 160 is driven on and off according to the current switching under the control of the vibration motor driver 150. By switching the current supplied to the vibration motor 160 according to the control signal input from the vibration control task 140, the vibration motor driver 150 adjusts a corresponding long and short current supply.

For example, if the text supplied from the SMS task 110 is “A”, the transformer task 130 detects a digital code corresponding to Morse code “•-” and provides the digital code to the vibration control task 140. The vibration control task 140 then provides the digital code to the vibration motor driver 150 as a control signal. In response to the control signal, the vibration motor driver 150 controls the vibration motor 160 in a sequence such as “drive-on vibration motor for 1 second→drive-off vibration motor for 1 second→drive-on vibration motor for 2 seconds→sustain drive-off of vibration motor”.

The above example illustrates a case where a control signal corresponding to the Morse code “•” is set to ‘drive-on the vibration motor 160 for 1 second’, a control signal corresponding to an interval between codes is set to ‘drive-off the vibration motor for 1 second’ and a control signal corresponding to the Morse code “-” is set to ‘drive-on the vibration motor for 2 seconds’.

In this way, a user recognizes the Morse code by tactilely sensing the drive-on/off of the vibration motor 160 and then recognizes that the received text is “A”. The user must already be aware of the Morse codes. In another embodiment of the present invention, a strength and weakness of the current or voltage supplied to the vibration motor 160 can be adjusted instead of turning the drive of the vibration motor on and off.

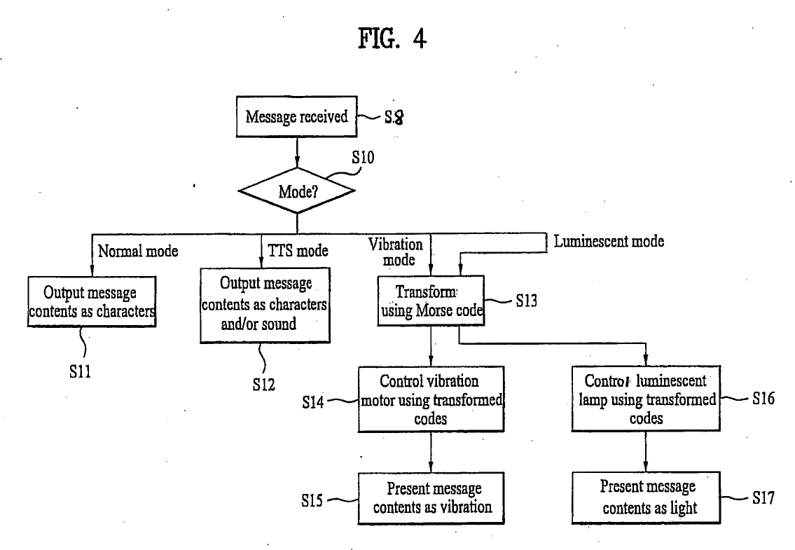

A mobile station (MS) according to the present invention is provided with elements for message transformation and outputs a received message in different ways according to four types of operational modes; a normal mode, a TTS mode, a vibration mode and a luminescent mode. Assuming that a message received according to FIG. 3 is a character message, a transformation procedure for the character message according to each operational mode is illustrated with reference to FIG. 4.

FIG. 4 illustrates a flowchart of a process for transforming a character message according to the present invention. As illustrated in FIG. 4, a mobile station receives a character message transmitted from a message center (MC) via a base station (BS) (S8).

Once the character message is received, the mobile station (MS) identifies a current operational mode (S10). The mobile station (MS) operates according to the identified operational mode.

In the normal mode, the mobile station (MS) outputs contents of the received character message as text (S11). The output means is a display device, such as a liquid crystal display (LCD). Therefore, the normal mode is adapted for a user having normal vision.

In the TTS mode, the mobile station outputs contents of the received character message as text and/or voice (S12). The output means is a display device, such as a liquid crystal display (LCD), and/or a sound output device, such as a speaker. If a user previously selected voice output only, the contents of the received character message are output as voice only. Therefore, the TTS mode is adapted for a user having normal vision and also adapted for a visually disabled user having normal hearing.

In the vibration mode, the mobile station transforms contents of a received character message into digital codes with reference to a transformation table 120 storing information relating text to Morse codes (S13). The digital codes represent Morse codes digitally. Once the contents of the character message are entirely transformed into the digital codes, a single digital signal is created. Subsequently, the mobile station (MS) controls a vibration motor 160 using the digital signal as a control signal (S14).

The vibration motor 160 presents message contents as vibration according to the control signal (S15). Specifically, the vibration motor 160 is either turned on and off or the strength or weakness of the drive of the vibration motor is adjusted according to the control signal.

By utilizing the vibration mode, a user can recognize the contents of the message as Morse codes. The vibration mode is adapted for a user having normal vision and also for a user who has a visual and/or auditory disability. Additionally, the vibration motor 160 may be activated in a manner such that a ring tone is cut off in receiving a message or voice call when the vibration mode is enabled

In the luminescent mode, the mobile station (MS) transforms contents of a received character message into digital codes with reference to a transformation table 120 storing information relating text to Morse codes (S13). The digital codes represent Morse codes digitally. Once the contents of the character message are entirely transformed into the digital codes, a single digital signal is created. Subsequently, the mobile station (MS) controls a luminescent lamp, such as a light-emitting diode, using the digital signal as a control signal (S16).

The luminescent lamp presents message contents as light according to the control signal (S17). Specifically, the luminescent lamp is turned on and off according to the control signal. Therefore, a user can recognize the contents of the message as Morse codes via a flickering light. Additionally, the message contents may be presented as light by controlling the on/off states of a backlight of the mobile station instead of using a separate luminescent lamp. The luminescent mode is adapted for a user having normal vision and also for a user having an auditory disability, but who is capable of discerning brightness.

As illustrated, the present invention transforms a received voice or character message using Morse code as one telegraphic code. However, the present invention is not limited to Morse code for transforming a voice or character message.

The present invention may utilize any code system that uses a combination of long and short current switching or a combination of strength and weakness of current or voltage to represent shapes of characters, numbers and symbols. For example, a 5-unit or 6-unit code as printing telegraphy may be utilized for character message transformation. Additionally, the illustrated utilization of Morse code is representative of International Morse Code, Continental Morse Code and Radiotelegraphic Code as well as American Morse.

In the above-explained description of the present invention, a character message is transformed into Morse code. However, the character message to be transformed into Morse code is not limited to a character message configured with numbers, characters and symbols.

The present invention is also applicable to a voice message having a prescribed length that is transformed into Morse code for output in the vibration mode. In order to transform a voice message into Morse code, an intermediate step of converting a voice message to a character message is required.

According to the present invention, if a format of a character message is an image format, such as a video message, only text as character information is extracted from the video message. The extracted text is transformed into Morse code and a corresponding Morse code sequence is output as vibration or light.

The present invention provides advantages over the prior art. The present invention outputs a received message using vibration or light, thereby facilitating a message transmission service for a special purpose or for specific users, such as handicapped users. Specifically, the present invention provides handicapped users with a message transmission service and can be further extended to emergency or military use.

It will be apparent to those skilled in the art that various modifications and variations can be made in the present invention without departing from the spirit or scope of the invention. As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method of presenting a message in a mobile communications terminal, the method comprising:
transforming a received message into a digital signal; and
presenting the content of the received message to a user via at least one of vibration and light.

2. The method of claim 1, wherein the received message is a character message comprising text configured with at least one of characters, numbers and symbols.

3. The method of claim 1, wherein the received message is a voice message.

4. The method of claim 1, wherein transforming the received message comprises utilizing digital codes representing a Morse code dot and a Morse code dash.

5. The method of claim 4, wherein presenting the content of the received message comprises generating a first signal and a second signal for controlling at least one of a drive current and a drive voltage, the first signal corresponding to the Morse code dot and the second signal corresponding to the Morse code dash.

6. The method of claim 5, wherein transforming the received message further comprises utilizing digital codes that cause the at least one of a drive current and a drive voltage to be applied for a shorter time for the Morse code dot than for the Morse code dash.

7. The method of claim 1, wherein presenting the content of the received message comprises controlling a luminescent lamp using the digital signal as a control signal.

8. The method of claim 7, wherein transforming the received message comprises utilizing digital codes representing a Morse code dot and a Morse code dash in order to generate signals for controlling at least one of a drive current and a drive voltage of the luminescent lamp such the at least one of a drive current and a drive voltage of the luminescent lamp is applied for a shorter time for the Morse code dot than for the Morse code dash.

9. The method of claim 1, wherein presenting the content of the received message comprises controlling a vibration device using the digital signal as a control signal.

10. The method of claim 9, wherein transforming the received message comprises utilizing digital codes representing a Morse code dot and a Morse code dash in order to generate signals for controlling at least one of a drive current and a drive voltage of the vibration device such the at least one of a drive current and a drive voltage of the vibration device is applied for a shorter time for the Morse code dot than for the Morse code dash.

11. The method of claim 1, further comprising presenting the content of the received message to a user at least one of textually and audibly.

12. The method of claim 1, wherein the received message is a video message comprising images and further comprising extracting text from the video message and transforming the extracted text into a digital signal.

13. A method of transforming a message in a mobile communications terminal, the method comprising:
presenting the content of a received message to a user via at least one of a visual display and a speaker;
transforming the received message into a digital signal; and
presenting the content of the received message to a user via at least one of a vibration device and an illuminating device.

14. The method of claim 13, wherein the received message is one of a character message and a voice message, the character message comprising text configured with at least one of characters, numbers and symbols.

15. The method of claim 13, wherein transforming the received message comprises utilizing digital codes representing a Morse code dot and a Morse code dash and presenting the content of the received message comprises generating a first signal and a second signal for controlling at least one of a drive current and a drive voltage of the at least one of a vibration device and an illuminating device, the first signal corresponding to the Morse code dot and the second signal corresponding to the Morse code dash such that the at least one of a drive current and a drive voltage is applied for a shorter time for the Morse code dot than for the Morse code dash.

16. A mobile communication terminal, comprising:
a transforming unit adapted to transform a received message into a digital signal;
a presenting unit adapted to represent the content of the received message to a user, the unit comprising at least one of a vibration device and a luminescent lamp; and
a control unit adapted to control the presenting unit using the digital signal as a control signal.

17. The mobile communication terminal of claim 16, wherein the transforming unit is further adapted to transform a received character message comprising text configured with at least one of characters, numbers and symbols.

18. The mobile communication terminal of claim 16, wherein the transforming unit is further adapted to transform a received voice message.

19. The mobile communication terminal of claim 16, wherein the transforming unit is further adapted to utilize digital codes representing a Morse code dot and a Morse code dash.

20. The mobile communication terminal of claim 19, further comprising a memory unit adapted to store the digital codes and wherein the transforming unit is further adapted to transform the received message into the digital signal with reference to the memory.

21. The mobile communication terminal of claim 19, wherein the control unit is further adapted to generate a first signal and a second signal for controlling at least one of a drive current and a drive voltage of the presenting unit, the first signal corresponding to the Morse code dot and the second signal corresponding to the Morse code dash.

22. The mobile communication terminal of claim 21, wherein the control unit is further adapted to cause the at least one of a drive current and a drive voltage to be applied for a shorter time for the Morse code dot than for the Morse code dash.

23. The mobile communication terminal of claim 16, further comprising at least one of a visual display unit and a sound display unit and wherein the control unit is further adapted to control the presenting unit and the at least one of the visual display unit and the sound display unit such that the content of the received message is represented to a user in a plurality of formats.
